(19) United States
(12) Patent Application Publication
(10) Pub. No.: US 2023/0026513 A1
(43) Pub. Date: Jan. 26, 2023

(54) HUMAN INTERFACE DEVICE

(71) Applicant: NextMind SAS, Paris (FR)

(72) Inventors: Sid Kouider, Paris (FR); Nelson Steinmetz, Paris (FR); Robin Zerafa, Paris (FR)

(21) Appl. No.: 17/778,619

(22) PCT Filed: Nov. 23, 2020
(86) PCT No.: PCT/EP2020/083088

§ 371 Date: May 20, 2022

Related U.S. Application Data
(60) Provisional application No. 62/938,753, filed on Nov. 21, 2019.

(51) Int. Cl. G06F 3/01; G02B 27/00

(52) U.S. Cl. CPC G06F 3/015; G02B 27/0093

(57) ABSTRACT

A human interface device comprising an eye tracking unit configured to determine the direction of gaze of a user and a brain-computer interface in which visual stimuli are presented such that the intention of the user can be validated, offering an improved and intuitive user experience. Method of operating said human interface device.

### CROSS-REFERENCE TO RELATED APPLICATIONS

This application claims the benefit of priority from U.S. Provisional Patent Application Ser. No. 62/938,753, entitled “HUMAN INTERFACE DEVICE” and filed Nov. 21, 2019, which is incorporated by reference herein in its entirety.

### TECHNICAL FIELD OF THE INVENTION

Embodiments of the present disclosure relate to a human interface device incorporating brain-computer interfaces involving visual sensing.

### STATE OF THE ART

In visual brain-computer interfaces (BCIs), neural responses to a target stimulus, generally among a plurality of generated visual stimuli presented to the user, are used to infer (or “decode”) which stimulus is essentially the object of focus at any given time. The object of focus can then be associated with a user-selectable or -controllable action.

Neural responses may be obtained using a variety of known techniques. One convenient method relies upon surface electroencephalography (EEG), which is non-invasive, has fine-grained temporal resolution and is based on well-understood empirical foundations. Surface EEG makes it possible to measure the variations of diffuse electric potentials on the surface of the skull (i.e. the scalp) of a subject in real-time. These variations of electrical potentials are commonly referred to as electroencephalographic signals or EEG signals.

In a typical BCI, visual stimuli are presented in a display generated by a display device. Examples of suitable display devices (some of which are illustrated in FIG. 3) include television screens & computer monitors 302, projectors 310, virtual reality headsets 306, interactive whiteboards, and the display screen of tablets 304, smartphones, smart glasses 308, etc. The visual stimuli 311, 311′, 312, 312′, 314, 314′, 316, 318 may form part of a generated graphical user interface (GUI) or they may be presented as augmented reality (AR) or mixed reality graphical objects 316 overlaying a base image: this base image may simply be the actual field of view of the user (as in the case of a mixed reality display function projected onto the otherwise transparent display of a set of smart glasses) or a digital image corresponding to the user's field of view but captured in real time by an optical capture device (which may in turn capture an image corresponding to the user's field of view amongst other possible views).

Inferring which of a plurality of visual stimuli (if any) is the object of focus at any given time is fraught with difficulty. For example, when a user is facing multiple stimuli, such as for instance the digits displayed on an on-screen keypad, it has proven nearly impossible to infer which one is under focus directly from brain activity at a given time. The user perceives the digit under focus, say digit 5, so the brain must contain information that distinguishes that digit from others, but current methods are unable to extract that information. That is, current methods can, with some difficulty, infer that a stimulus has been perceived, but they cannot determine which specific stimulus is under focus using brain activity alone.

To overcome this issue and to provide sufficient contrast between stimulus and background (and between stimuli), it is known to configure the stimuli used by visual BCIs to blink or pulse (e.g. large surfaces of pixels switching from black to white and vice-versa), so that each stimulus has a distinguishable characteristic profile over time. The flickering stimuli give rise to measurable electrical responses. Specific techniques monitor different electrical responses, for example steady state visual evoked potentials (SSVEPs) and P-300 event related potentials. In typical implementations, the stimuli flicker at a rate exceeding 6 Hz. As a result, such visual BCIs rely on an approach that consists of displaying, the various stimuli discretely rather than constantly, and at typically at different points in time. Brain activity associated with attention focused on a given stimulus is found to correspond (i.e. correlate) with one or more aspect of the temporal profile of that stimulus, for instance the frequency of the stimulus blink and/or the duty cycle over which the stimulus alternates between a blinking state and a quiescent state.

Thus, decoding of neural signals relies on the fact that when a stimulus is turned on, it will trigger a characteristic pattern of neural responses in the brain that can be determined from electrical signals, i.e. the SSVEPs or P-300 potentials, picked up by electrodes of an EEG device, the electrodes of an EEG helmet, for example. This neural data pattern might be very similar or even identical for the various digits, but it is time-locked to the digit being perceived: only one digit may pulse at any one time so that the correlation with a pulsed neural response and a time at which that digit pulses may be determined as an indication that that digit is the object of focus. By displaying each digit at different points in time, turning that digit on and off at different rates, applying different duty cycles, and/or simply applying the stimulus at different points in time, the BCI algorithm can establish which stimulus, when turned on, is most likely to be triggering a given neural response, thereby allowing a system to determine the target under focus.

Visual BCIs have improved significantly in recent years, so that real-time and accurate decoding of the user's focus is becoming increasingly practical. Nevertheless, the constant blinking of the stimuli, sometimes all over the screen when there are many of them, is an intrinsic limitation for a large-scale use of this technology. Indeed, it can cause discomfort and mental fatigue, and, if sustained, physiological responses such as headaches.

In addition, the blinking effect can impede the ability of the user to focus on a specific target, and the system to determine the object of focus quickly and accurately. For instance, when a user of the on-screen keypad discussed above tries to focus on digit 5, the other (i.e., peripheral) digits act as distractors, their presence and the fact that they are exhibiting a blinking effect drawing the user's attention momentarily. The display of the peripheral digits induces interference in the user's visual system. This interference in turn impedes the performance of the BCI. Consequently, there is a need for an improved method for differentiating screen targets and their display stimuli in order to determine which one a user is focusing on.

Other techniques are known for determining the object of focus at any given time. It is, for instance, known to track the direction of gaze of the user by tracking changes in the position of the eye of the user relative to their head. This technique typically requires the user to wear a head-mounted device with cameras directed at the user's eyes. In certain instances, of course, the eye tracking cameras may be fixed relative to the floor or a wheelchair, rather than head-mounted. An object found to be positioned in the determined direction of gaze may then be assumed to be the object of focus.

Direction of gaze is, however, considered to be a relatively poor indicator of intention to interact with that object.

It is therefore desirable to provide human interface devices that address the above challenges.

### SUMMARY

The present disclosure relates to a human interface device comprising an eye tracking unit configured to determine the direction of gaze of a user and a brain-computer interface in which visual stimuli are presented such that the intention of the user can be validated, offering an improved and intuitive user experience.

According to a first aspect, the present disclosure relates to a human interface device comprising: an eye tracking unit configured to determine the direction of gaze of a user; and a brain-computer interface in which at least one visual stimulus is presented, the visual stimulus being generated by a stimulus generator and having a characteristic modulation, such that the intention of the user can be validated, offering an improved and intuitive user experience.

According to a second aspect, the present disclosure relates to a method of operation of a human interface device to determine user intention, the method comprising: determining a direction of gaze of a user using an eye tracking unit with respect to a display of a display device; presenting at least one object in the display of a display device; determining that a given one of said at least one objects is an object of interest based on the determined direction of gaze; generating a visual stimulus having a characteristic modulation; applying the visual stimulus to the object of interest; receiving electrical signals corresponding to neural responses to the stimulus from a neural signal capture device; and validating that the object of interest is an intentional object of focus in accordance with a correlation between the electrical signals and characteristic modulation of the visual stimulus.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an electronic architecture for receiving and processing EEG signals according to the present disclosure;

FIG. 2 illustrates a system incorporating a brain computer interface (BCI) according to the present disclosure;

FIG. 3 illustrates various examples of display device suitable for use with the BCI system of the present disclosure;

FIG. 4 illustrates main functional components in an eye tracking unit according to the present disclosure;

FIGS. 5A and 5B illustrate respective examples of human interface device in accordance with the present disclosure;

FIG. 6 illustrates the main functional blocks in the method of operation of a human interface device in accordance with the present disclosure.

FIG. 7 is block diagram showing a software architecture within which the present disclosure may be implemented, in accordance with some example embodiments; and

FIG. 8 is a diagrammatic representation of a machine, in the form of a computer system within which a set of instructions may be executed for causing the machine to perform any one or more of the methodologies discussed, in accordance with some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

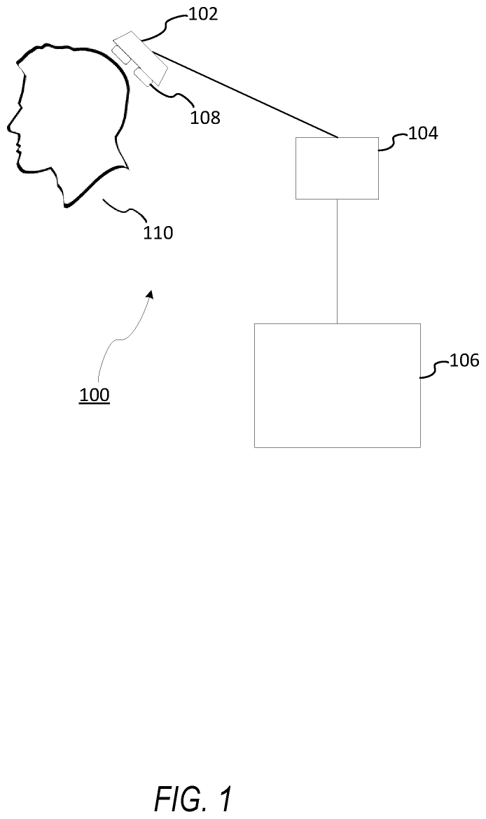

FIG. 1 illustrates an example of an electronic architecture for the reception and processing of EEG signals by means of an EEG device 100 according to the present disclosure.

To measure diffuse electric potentials on the surface of the skull of a subject 110, the EEG device 100 includes a portable device 102 (i.e. a cap or headpiece), analog-digital conversion (ADC) circuitry 104 and a microcontroller 106. The portable device 102 of FIG. 1 includes one or more electrodes 108, typically between 1 and 128 electrodes, advantageously between 2 and 64, advantageously between 4 and 16.

Each electrode 108 may comprise a sensor for detecting the electrical signals generated by the neuronal activity of the subject and an electronic circuit for pre-processing (e.g. filtering and/or amplifying) the detected signal before analog-digital conversion: such electrodes being termed “active”. The active electrodes 108 are shown in use in FIG. 1, where the sensor is in physical proximity with the subject's scalp. The electrodes may be suitable for use with a conductive gel or other conductive liquid (termed “wet” electrodes) or without such liquids (i.e. “dry” electrodes).

Each ADC circuit 104 is configured to convert the signals of a given number of active electrodes 108, for example between 1 and 128.

The ADC circuits 104 are controlled by the microcontroller 106 and communicate with it for example by the protocol SPI (“Serial Peripheral Interface”). The microcontroller 106 packages the received data for transmission to an external processing unit (not shown), for example a computer, a mobile phone, a virtual reality headset, an automotive or aeronautical computer system, for example a car computer or a computer system. airplane, for example by Bluetooth, Wi-Fi (“Wireless Fidelity”) or Li-Fi (“Light Fidelity”).

In certain embodiments, each active electrode 108 is powered by a battery (not shown in FIG. 1). The battery is conveniently provided in a housing of the portable device 102.

In certain embodiments, each active electrode 108 measures a respective electric potential value from which the potential measured by a reference electrode (Ei=Vi−Vref) is subtracted, and this difference value is digitized by means of the ADC circuit 104 then transmitted by the microcontroller 106.

In certain embodiments, the method of the present disclosure introduces target objects for display in a graphical user interface of a display device. The target objects include control items and the control items are in turn associated with user-selectable actions.

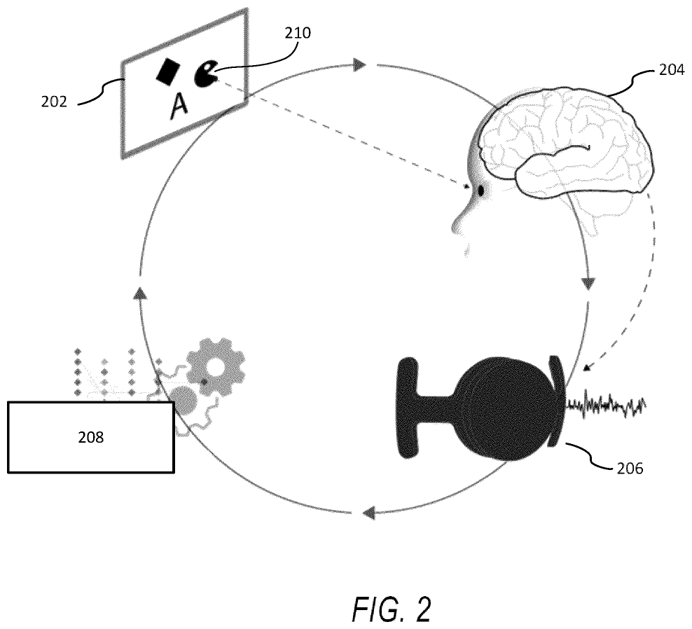

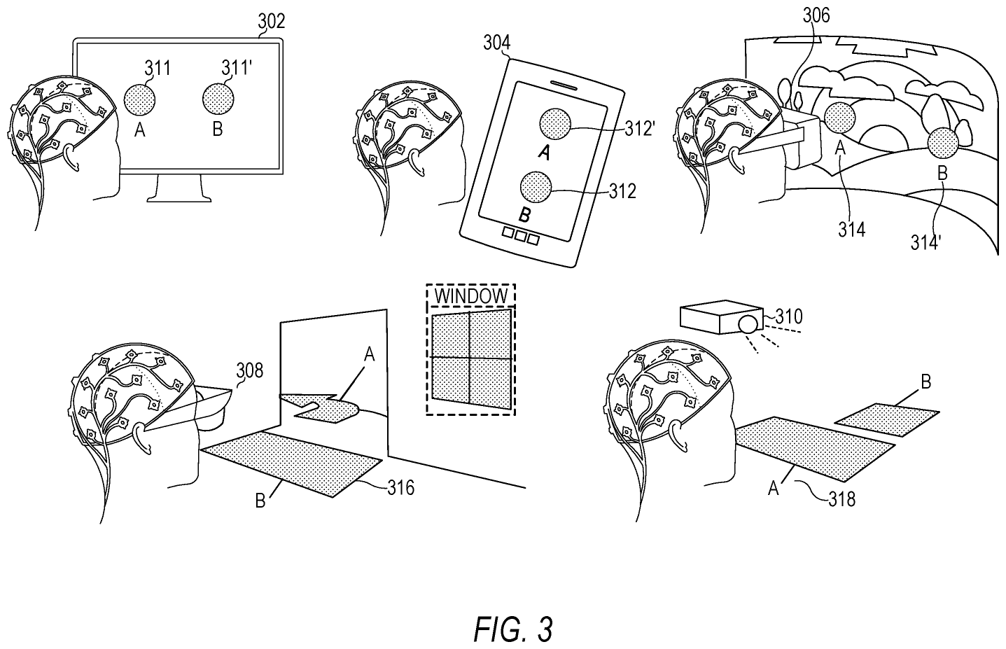

FIG. 2 illustrates a system incorporating a brain computer interface (BCI) according to the present disclosure. The system incorporates a neural response device 206, such as the EEG device 100 illustrated in FIG. 1. In the system, an image is displayed on a display of a display device 202. The subject 204 views the image on the display, focusing on a target object 210.

In an embodiment, the display device 202 displays at least the target object 210 as a graphical object with a varying temporal characteristic distinct from the temporal characteristic of other displayed objects and/or the background in the display. The varying temporal characteristic may be, for example, a constant or time-locked flickering effect altering the appearance of the target object at a rate greater than 6 Hz. Where more than one graphical object is a potential target object (i.e. where the viewing subject is offered a choice of target object to focus attention on), each object is associated with a discrete spatial and/or temporal code.

The neural response device 206 detects neural responses (i.e. tiny electrical potentials indicative of brain activity in the visual cortex) associated with attention focused on the target object; the visual perception of the varying temporal characteristic of the target object(s) therefore acts as a stimulus in the subject's brain, generating a specific brain response that accords with the code associated with the target object in attention. The detected neural responses (e.g. electrical potentials) are then converted into digital signals and transferred to a processing device 208 for decoding. Examples of neural responses include visual evoked potentials (VEPs), which are commonly used in neuroscience research. The term VEPs encompasses conventional SSVEPs, as mentioned above, where stimuli oscillate at a specific frequency and other methods such as the code-modulated VEP, stimuli are subject to a variable or pseudo-random temporal code.

The processing device 208 executes instructions that interpret the received neural signals to determine feedback indicating the target object having the current focus of (visual) attention in real time. Decoding the information in the neural response signals relies upon a correspondence between that information and one or more aspect of the temporal profile of the target object (i.e. the stimulus).

In certain embodiments, the processing device may conveniently generate the image data presented on the display device 202 including the temporally varying target object.

The feedback may conveniently be presented visually on the display screen. For example, the display device may display an icon, cursor, crosshair or other graphical object or effect in close proximity to the target object, highlighting the object that appears to be the current focus of visual attention. Clearly, the visual display of such feedback has a reflexive cognitive effect on the perception of the target object, amplifying the brain response. This positive feedback (where the apparent target object is confirmed as the intended target object by virtue of prolonged amplified attention) is referred to herein as “neurosynchrony”.

Research into the way in which the human visual sensing operates has shown that, when peering at a screen with multiple objects and focusing on one of those objects, the human visual system will be receptive to both high spatial frequencies (HSF) and low spatial frequencies (LSF). Evidence shows that the human visual system is primarily sensitive to the HSF components of the specific display area being focused on (e.g. the object the user is staring at). For peripheral objects, conversely, the human visual system is primarily sensitive to their LSF components. In other words, the neural signals picked up will essentially be impacted by both the HSF components from the target under focus and the LSF components from the peripheral targets. However, since all objects evoke some proportion of both HSF and LSF, processing the neural signals to determine the focus object can be impeded by the LSF noise contributed by peripheral objects. This tends to make identifying the object of focus less accurate and less timely.

As the human visual system is tuned to process parallel multiple stimuli at different locations of the visual field, typically unconsciously, peripheral object stimuli will continue triggering neural responses in the users' brains, even if they appear in the periphery of the visual field. As a result, this poses competition among multiple stimuli and renders the specific neural decoding of the object of focus (the target) more difficult.

Co-pending International patent application number PCT/EP2020/081348 filed on Nov. 6, 2020 (docket number 5380.002WO1), the entire specification of which is incorporated herein by reference, describes one approach, a plurality of objects is displayed in such a way that each one is separated into a version composed only of the LSF components of the object and a version composed of only HSF components. The blinking visual stimulus used to elicit a decodable neural response is conveyed only through the HSF version of the object. The blinking HSF version is superimposed on the LSF version (which does not blink).

Known systems in the medical or related research fields generally include a head-mounted device with attachment locations for receiving individual sensors/electrodes. Electronic circuits are then connected to the electrodes and to the housing of an acquisition chain (i.e. an assembly of connected components used in acquiring the EEG signals). The EEG device is thus typically formed of three distinct elements that the operator/exhibitor must assemble at each use. Again, the nature of the EEG device is such that technical assistance is desirable if not essential.

As noted above, a BCI is not the only technique for monitoring for objects of focus. One particular class of techniques attempts to track the movements of the eyes of the user. The assumption here being that if the direction of gaze (particularly at instances when the eye remains fixed in a given direction, termed “fixations”) can be determined from the tracked eye movements, the objects lying in the determined direction can be considered objects of focus.

The position of the eyes (and by extension the direction of gaze) is determined by one of a number of techniques including optical tracking, electro-ocular tracking or fixing a motion-tracking device to the surface of the eye, in the form of a contact lens, say. The commonest eye tracking techniques track features of the eye in video images captured by cameras, typically digital cameras operating in the infrared or near-infrared, focused on one or more structure of the eye (such as the cornea, the lens or the retina). Electro-ocular tracking, by contrast, measures electrical potentials generated by the various motor muscles around the eye: this technique can be made sensitive to movements of the eye, even when the eyes are closed.

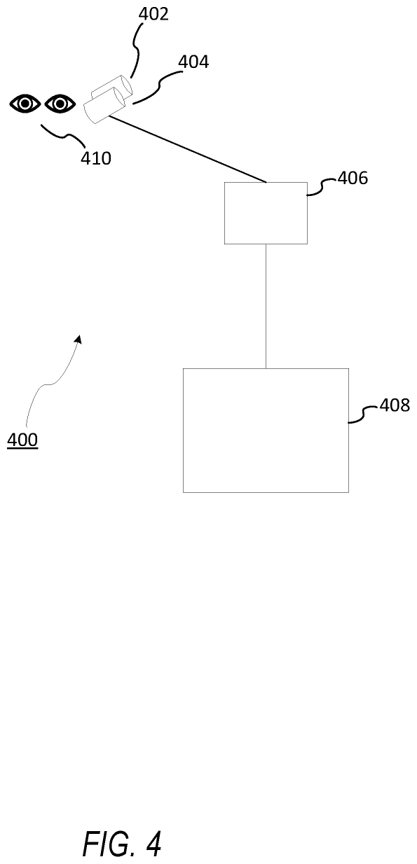

FIG. 4 shows a typical eye tracking system 400 in accordance with the present disclosure.

In the illustrated optical tracking technique, the output of respective eye tracking cameras 402, 404 is processed in an eye tracking unit 406. The eye tracking unit 406 outputs eye tracking information including fixation information to a processing device 408.

Eye tracking information typically indicates the angle of a notional point of gaze relative to fixed direction (such as a reference direction of the head). Conventional eye tracking techniques, even those using a camera for each of the user's eyes) generate information that is essentially two-dimensional—capable of discriminating points on a virtual sphere around the user's head but having difficulty capturing depth with any accuracy. Binocular eye tracking techniques are in development that attempt to resolve between different depths (i.e. distances from the user) using tracking information for more than one eye. Such techniques require considerable amounts of calibration to the particular user before they can be utilized with any reliability.

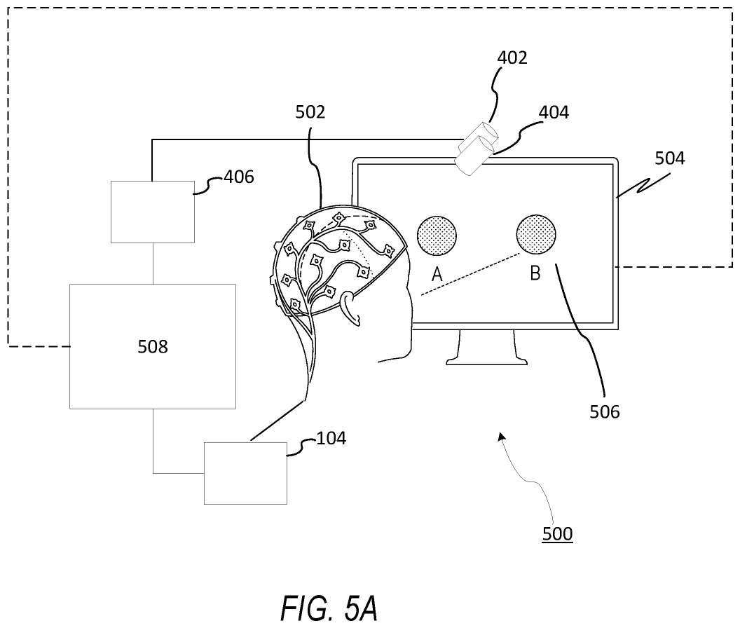

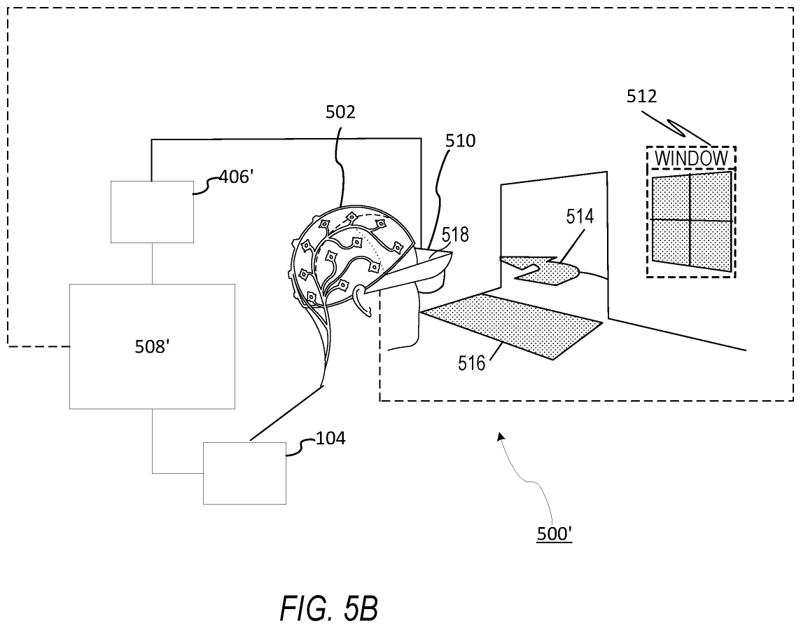

FIG. 5A illustrates a human interface device 500 in accordance with the present disclosure. The human interface device includes a BCI, such as that illustrated in FIGS. 1 and 2, and an eye tracking system, such as that illustrated in FIG. 4.

In certain embodiments, the eye tracking system is used to determine the direction of (fixed) gaze of the user. A command including this determined direction is then transmitted as a control signal to an external processing unit 508 (such as the processing unit 208 of FIG. 2) indicating that a given object (object B, 506, say) is potentially an object of focus.

In the illustrated embodiment, the external processing unit 508 includes a stimulus generator for generating visual stimuli having respective characteristic modulations. The external processing unit 508 then applies a visual stimulus to that object 506 (for instance by projecting the visual stimulus onto objects in the line of the determined direction of gaze or, as illustrated here, by controlling a display screen object in a display presented by a display device 504).

The eye tracker unit 406 and/or cameras 402, 404 may conveniently be placed as a display-top camera arrangement (as illustrated in FIG. 5A) or worn in a head-piece (see FIG. 5B below).

FIG. 5B illustrates another exemplary human interface device 500′ in accordance with the present disclosure. The human interface device includes a BCI, such as that illustrated in FIGS. 1 and 2, and an eye tracking system in the form of a head-piece 510 for augmented, mixed or virtual reality. The human interface device 500′ includes an eye tracker unit 406′, which processes the output of respective eye tracking cameras embedded in the head-piece 510. The illustrated human interface device 500′ is external to the head-piece 510, however it too may be conveniently incorporated with in the head-piece 510.

As for FIG. 5A, the eye tracking system of FIG. 5B may be used to determine the direction of (fixed) gaze of the user. In FIG. 5B, however, the gaze of the user rests upon real-world objects overlaid by one or more visual stimulus reproduced in a display (e.g. an otherwise transparent “head up” display) that is provided in the head-piece 510.

A command including this determined direction is then transmitted from the eye tracker unit 406′ as a control signal to an external processing unit 508′ (such as the processing unit 208 of FIG. 2) indicating that a given object (window, 512, say) is potentially an object of focus.

In the illustrated embodiment, the external processing unit 508′ includes a stimulus generator for generating visual stimuli having respective characteristic modulations. The external processing unit 508′ then applies a visual stimulus to the window object 506 (for instance by projecting the visual stimulus onto objects in the line of the determined direction of gaze or, as illustrated here, by controlling the head-piece display 518 to overlay a visual stimulus in a portion of the display corresponding to the determined direction of gaze).

In the examples of FIGS. 5A and 5B, eye-tracking may be used to generate a first, coarse, approximation of the object of focus. In certain embodiments, where the eye-tracking information is sufficient to allow the inference of a single object as the likely object of focus, a single visual stimulus may be presented over the sole candidate so that the human interface device may determine whether the object in the direction of the gaze is in fact an object with which the user wishes to interact. Furthermore, even if more than one visual stimulus is generated (say for objects 514, 516 as well as window 512 in FIG. 5B), provided only one visual stimulus is presented in the direction indicated by the direction of gaze, it may be inferred that this object (the window, 512, say) is indeed the intended object, the BCI may then serve to confirm not only that the user is looking at that object but also that their gaze is intentionally applied to that object. The eye-tracking system allows the human interface device to apply computational capacity economically—since visual stimuli away from the direction of gaze may either be discounted as likely candidates for focus of attention or even simply not generated in the first place.

The neurosynchrony feedback loop described above ensures that sustained focused attention to the object to which the visual stimulus is applied will strengthen the neural response, thereby validating or confirming the initial inference that the object associated with the eye-tracking target is indeed the object of focus for the user. The feedback loop also provides greater ease of use (i.e. in terms of the user experience) as it gives the user an accessible and intuitive representation of the action currently happening, analogous to the haptic feedback experienced by the finger pressing a physical key. This in turn gives the user a better, more progressive sense of control.

In the example of a single visual stimulus presented in the display 518 of the head-piece 510, that may be presented in the determined direction of gaze. Conveniently the provision of that visual stimulus as an icon, cursor, crosshair or other graphical object or effect that overlays real world objects allows the user to gaze at an unlimited number of objects highlighting each object in the direction of gaze and when lighting upon an object to which focus of visual attention is intended may be used to infer an intention with respect to that object. Thus, the user gazing at window 512 may cause a crosshair stimulus to appear over the window and thus perceive that the human interface device has inferred (correctly) that the window is the focus of attention.

Determination of focus of attention upon a visual display of a controllable device may in turn be used to address a command to a controllable object, exerting control over that object. The controllable object may then implement an action based on said command: for example the controllable object may emit an audible sound, unlock a door, switch on or off, change an operational state, triggering an information request, the toggling of control states of real-world objects, the activation/selection of objects (e.g., for control) in mixed reality settings, etc.

In other scenarios, there may be a large number of possible objects of attention. For example, each of the keys of an alpha-numeric keyboard may be a distinct candidate for object of attention. In such cases, the eye-tracking system may serve to reduce the number of candidates, allowing the BCI to expend less computational resource on unlikely candidates. As simple implementation might divide a displayed keyboard into sections: Left hand side, central and right hand side. Once gaze has been determined to be directed to one of these sections, visual stimuli in the other sections may be paused or discounted from determinations of object of attention. The reader will appreciate that the same principle may be applied in many other scenarios, such as the positions of sliders in a mixing desk interface or the choice of a particular colour from a colour gamut. In essence, application of the eye tracking system improves decodability in the operation of the BCI.

In cases where two objects, each with a respective, distinct, associated visual stimulus, are close to the same line of sight but at different depths of field, eye tracking alone is generally unable to infer reliably which is the object of attention. With the assistance of BCI however it becomes possible to make such a determination with greater precision.

Furthermore, in cases where only a limited number of candidate objects are present, the hybrid use of both eye tracking and BCI may reduce the intrusive aspects of each system individually. Thus, the blinking visual stimuli may be kept to a lower level that would be effective with BCI alone, while the calibration needed for eye-tracking may be significantly reduced due to assistance from feedback from the BCI. Likewise, the feedback from the eye-tracking system may also serve to improve calibration of the BCI.

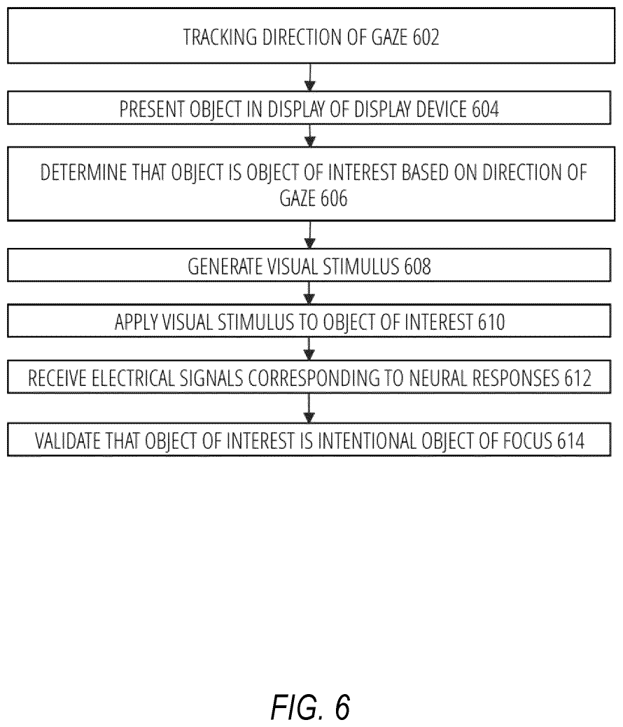

FIG. 6 illustrates the main functional blocks in the method of operation of a human interface device (for example, the human interface device illustrated in FIG. 5) in accordance with the present disclosure.

In block 602, the processing unit of the human interface device determines a direction of gaze of a user using an eye tracking unit with respect to a display of a display device. In block 604, the processing unit presents at least one object in the display of a display device. In block 606, the processing unit determines that a given one of the at least one objects is an object of interest based on the determined direction of gaze. In block 608, the processing unit generates a visual stimulus having a characteristic modulation. In block 610, the processing unit applies the visual stimulus to the object of interest. In block 612, the processing unit receives electrical signals corresponding to neural responses to the stimulus from a neural signal capture device. In block 614, the processing unit validates that the object of interest is an intentional object of focus in accordance with a correlation between the electrical signals and characteristic modulation of the visual stimulus.

The positive neurosynchrony feedback loop described in relation to the BCI in FIG. 2 may thus be employed to confirm the intent of the user, for example to initiate an action, in relation to an object determined to be the target of gaze by an eye tracking technique.

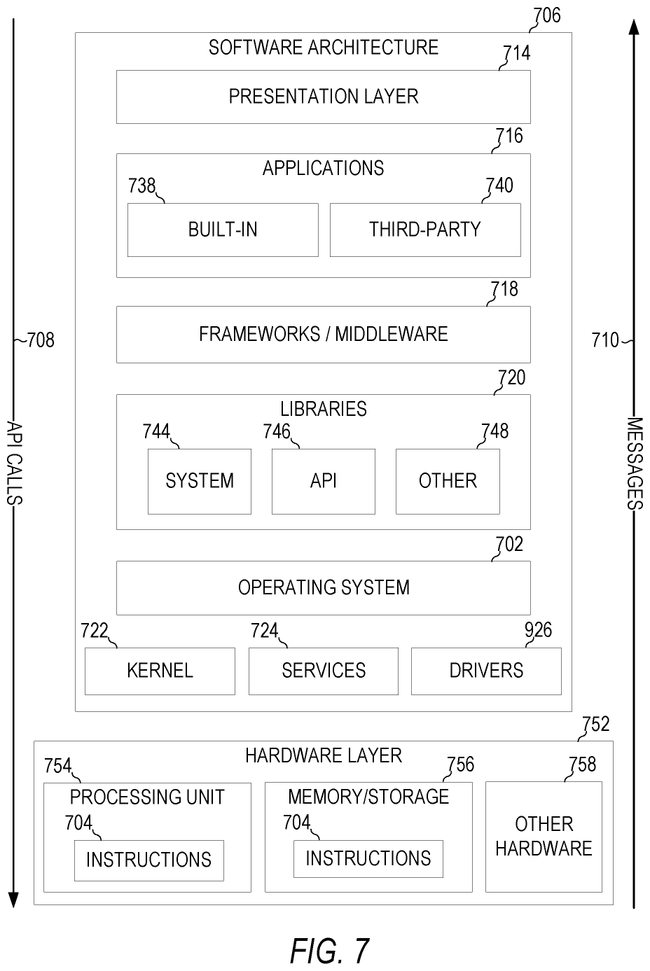

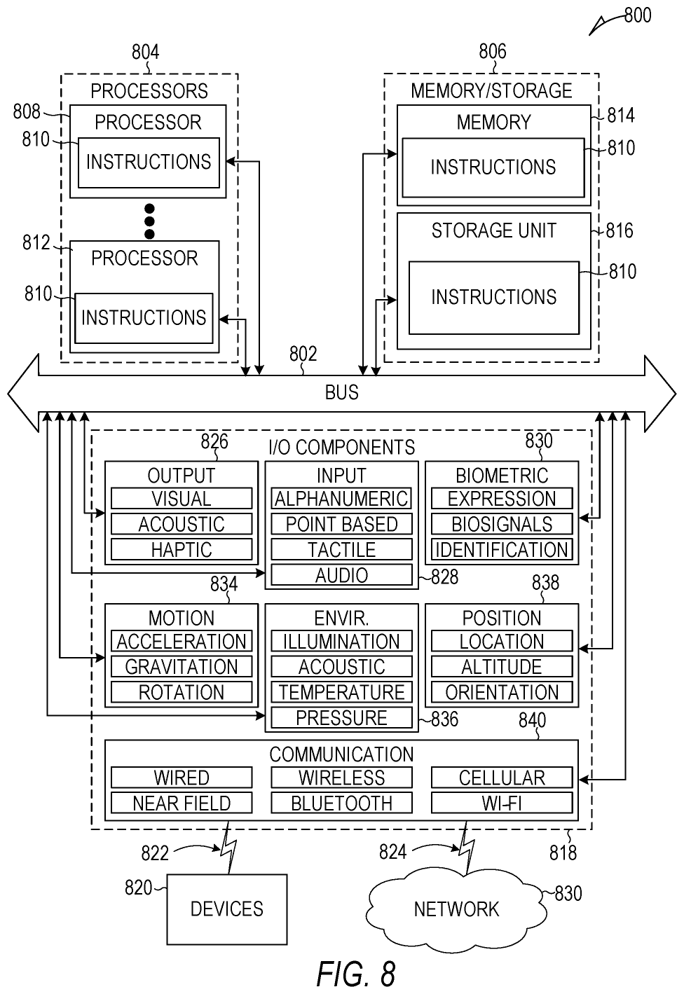

FIG. 7 is a block diagram illustrating an example software architecture 706, which may be used in conjunction with various hardware architectures herein described. FIG. 7 is a non-limiting example of a software architecture and it will be appreciated that many other architectures may be implemented to facilitate the functionality described herein. The software architecture 706 may execute on hardware such as machine 800 of FIG. 8 that includes, among other things, processors 804, memory 806, and input/output (I/O) components 818. A representative hardware layer 752 is illustrated and can represent, for example, the machine 800 of FIG. 8. The representative hardware layer 752 includes a processing unit 754 having associated executable instructions 704. The executable instructions 704 represent the executable instructions of the software architecture 706, including implementation of the methods, modules and so forth described herein. The hardware layer 752 also includes memory and/or storage modules shown as memory/storage 756, which also have the executable instructions 704. The hardware layer 752 may also comprise other hardware 758, for example dedicated hardware for interfacing with EEG electrodes, for interfacing with eye tracking units and/or for interfacing with display devices.

In the example architecture of FIG. 7, the software architecture 706 may be conceptualized as a stack of layers where each layer provides particular functionality. For example, the software architecture 706 may include layers such as an operating system 702, libraries 720, frameworks or middleware 718, applications 716 and a presentation layer 714. Operationally, the applications 716 and/or other components within the layers may invoke application programming interface (API) calls 708 through the software stack and receive a response as messages 710. The layers illustrated are representative in nature and not all software architectures have all layers. For example, some mobile or special purpose operating systems may not provide the frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 may be responsible for controlling or interfacing with the underlying hardware. For instance, the drivers 726 may include display drivers, EEG device drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 may provide a common infrastructure that may be used by the applications 716 and/or other components and/or layers. The libraries 720 typically provide functionality that allows other software modules to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematic functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks 718 (also sometimes referred to as middleware) provide a higher-level common infrastructure that may be used by the applications 716 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be used by the applications 716 and/or other software components/modules, some of which may be specific to a particular operating system or platform.

The applications 716 include built-in applications 738 and/or third-party applications 740.

The applications 716 may use built-in operating system functions (e.g., kernel 722, services 724, and/or drivers 726), libraries 720, or frameworks/middleware 718 to create user interfaces to interact with users of the system. Alternatively, or additionally, in some systems interactions with a user may occur through a presentation layer, such as the presentation layer 714. In these systems, the application/module “logic” can be separated from the aspects of the application/module that interact with a user.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory 806, and input/output (I/O) components 818, which may be configured to communicate with each other such as via a bus 802. In an example embodiment, the processors 804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that may execute the instructions 810. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory 806 may include a memory 814, such as a main memory, a static memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 810. The term “machine-readable medium” shall also be taken to include any medium, or combination of multiple media, that is capable of storing instructions (e.g., instructions 810) for execution by a machine (e.g., machine 800), such that the instructions, when executed by one or more processors of the machine 800 (e.g., processors 804), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 818 may include a wide variety of components to receive input, provide output, produce output, transmit information, exchange information, capture measurements, and so on. The specific input/output (I/O) components 818 that are included in a particular machine will depend on the type of machine. For example, user interface machines and portable machines such as mobile phones will likely include a touch input device or other such input mechanisms, while a headless server machine will likely not include such a touch input device. It will be appreciated that the input/output (I/O) components 818 may include many other components that are not shown in FIG. 8.

The input/output (I/O) components 818 are grouped according to functionality merely for simplifying the following discussion and the grouping is in no way limiting. In various example embodiments, the input/output (I/O) components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the input/output (I/O) components 818 may include biometric components 830, motion components 834, environment components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves, such as the output from an EEG device), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environmental environment components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 838 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 818 may include communication components 840 operable to couple the machine 800 to a network 832 or devices 820 via a coupling 824 and a coupling 822 respectively. For example, the communication components 840 may include a network interface component or other suitable device to interface with the network 832. In further examples, communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a Universal Serial Bus (USB)). Where an EEG device, an eye tracking unit or a display device is not integral with the machine 800, the device 820 may be an EEG device, an eye tracking unit and/or a display device.

Although described through a number of detailed exemplary embodiments, the portable devices for the acquisition of electroencephalographic signals according to the present disclosure comprise various variants, modifications and improvements which will be obvious to those skilled in the art, it being understood that these various variants, modifications and improvements fall within the scope of the subject of the present disclosure, as defined by the following claims.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Thus, the present disclosure describes a system and method for improving the accuracy, speed performance and visual comfort of BCIs.

### EXAMPLES

To better illustrate the system and methods disclosed herein, a non-limiting list of examples is provided here:

1. A human interface device comprising:
an eye tracking unit configured to determine the direction of gaze of a user; and
a brain-computer interface in which at least one visual stimulus is presented, the visual stimulus being generated by a stimulus generator and having a characteristic modulation,
such that the intention of the user can be validated, offering an improved and intuitive user experience.

2. A method of operation of a human interface device to determine user intention, the method comprising:
determining a direction of gaze of a user using an eye tracking unit with respect to a display of a display device;
presenting at least one object in the display of a display device;
determining that a given one of said at least one objects is an object of interest based on the determined direction of gaze;
generating a visual stimulus having a characteristic modulation;
applying the visual stimulus to the object of interest;
receiving electrical signals corresponding to neural responses to the visual stimulus from a neural signal capture device;
validating that the object of interest is an intentional object of focus in accordance with a correlation between the electrical signals and characteristic modulation of the visual stimulus.

3. The method of example 2, wherein the step of receiving electrical signals corresponding to neural responses comprises iteratively:
receiving the electrical signals;
generating an enhanced visual stimulus having the characteristic modulation; and
receiving further electrical signals corresponding to further neural responses to the enhanced visual stimulus from the neural signal capture device,

4. The method of example 2, wherein the object of focus is associated with a controllable object, the method further comprising:
transmitting a command to the controllable object associated with the object of focus, thereby controlling said controllable object to implement an action based on said command.

5. A computer-readable storage medium, the computer-readable storage medium carrying instructions that, when executed by a computer, cause the computer to perform operations comprising:
determining a direction of gaze of a user using an eye tracking unit with respect to a display of a display device;
presenting at least one object in the display of a display device;
determining that a given one of said at least one objects is an object of interest based on the determined direction of gaze;
generating a visual stimulus having a characteristic modulation;
applying the visual stimulus to the object of interest;
receiving electrical signals corresponding to neural responses to the visual stimulus from a neural signal capture device; and
validating that the object of interest is an intentional object of focus in accordance with a correlation between the electrical signals and characteristic modulation of the visual stimulus.

1. A human interface device comprising:
an eye tracking subsystem configured to determine the direction of gaze of a user; and
a brain-computer interface in which at least one visual stimulus is presented, the visual stimulus being generated by a stimulus generator and having a characteristic modulation.

2. The human interface device of claim 1, wherein the eye tracking subsystem includes an eye tracking unit that operates to determine the direction of gaze by at least one of: an optical tracking of one or more features of an eye of the user, an electro-ocular tracking of movements of the eye by measuring electrical potentials generated by motor muscles around the eye, or a fixing of a motion-tracking device to the surface of the eye.

3. The human interface device of claim 2, wherein the one or more tracked features include at least one of the following structures: a cornea, a lens or a retina of the eye.

4. The human interface device of claim 2, wherein the eye tracking subsystem further includes a camera, the camera being configured to capture successive images of the features of the eye, and
wherein the eye tracking subsystem is further configured to perform optical tracking of said tracked features using the camera.

5. The human interface device of claim 4, wherein the camera is a digital camera operating in the infrared or near-infrared wavelength,

6. The human interface device of claim 4, wherein the camera is incorporated in a head-piece configured to be worn by the user.

7. The human interface device of claim 6, wherein the eye tracking unit is incorporated within the head-piece.

8. The human interface device of claim 2, wherein the eye tracking unit is an electro-ocular tracking unit having the form of a contact lens.

9. A method of operation of a human interface device to determine user intention, the method comprising:
determining a direction of gaze of a user using an eye tracking unit with respect to a display of a display device;
presenting an object in the display of a display device;
determining that the object is an object of interest based on the determined direction of gaze;
generating a visual stimulus having a characteristic modulation;
applying the visual stimulus to the object of interest;
receiving electrical signals corresponding to neural responses to the visual stimulus from a neural signal capture device; and
validating that the object of interest is an intentional object of focus in accordance with a correlation between the electrical signals and the characteristic modulation of the visual stimulus.

10. The method of claim 9, wherein receiving electrical signals corresponding to neural responses comprises iteratively performing operations comprising:
receiving the electrical signals;
generating an enhanced visual stimulus having the characteristic modulation; and
receiving further electrical signals corresponding to further neural responses to the enhanced visual stimulus from the neural signal capture device,

11. The method of claim 9, wherein the object of focus is associated with a controllable object, the method further comprising:
controlling the controllable object to implement an action based on a command by transmitting the command to the controllable object associated with the object of focus.

12. The method of claim 9, wherein the generation of the visual stimulus depends upon the determined direction of gaze, the visual stimulus being generated only for the object determined to be the object of interest.

13. The method of claim 9, wherein the visual stimulus is applied only to the object determined to be the object of interest.

14. A non-transitory computer-readable storage medium, the computer-readable storage medium carrying instructions that, when executed by one or more processors of a computer, cause the computer to perform operations comprising:
determining a direction of gaze of a user using an eye tracking unit with respect to a display of a display device;
presenting an object in the display of a display device;
determining that the object is an object of interest based on the determined direction of gaze;
generating a visual stimulus having a characteristic modulation;
applying the visual stimulus to the object of interest;
receiving electrical signals corresponding to neural responses to the visual stimulus from a neural signal capture device; and
validating that the object of interest is an intentional object of focus in accordance with a correlation between the electrical signals and characteristic modulation of the visual stimulus.

15. The non-transitory computer-readable storage medium of claim 14, wherein the instructions that, when executed by the one or more processors, cause the computer to perform operations comprising receiving electrical signals corresponding to neural responses further cause the computer to iteratively perform operations comprising:
receiving the electrical signals;
generating an enhanced visual stimulus having the characteristic modulation; and
receiving further electrical signals corresponding to further neural responses to the enhanced visual stimulus from the neural signal capture device.

16. The non-transitory computer-readable storage medium of claim 14, wherein the object of focus is associated with a controllable object, and
wherein the instructions that, when executed by the one or more processors, further cause the computer to perform operations comprising:
controlling the controllable object to implement an action based on a command by transmitting the command to the controllable object associated with the object of focus.

17. The non-transitory computer-readable storage medium of claim 14, wherein the generation of the visual stimulus depends upon the determined direction of gaze, the visual stimulus being generated only for the object determined to be the object of interest.

18. The non-transitory computer-readable storage medium of claim 14, wherein the visual stimulus is applied only to the object determined to be the object of interest.
